(19) United States
(12) Patent Application Publication
(10) Pub. No.: US 2009/0300109 A1
(43) Pub. Date: Dec. 3, 2009

(54) SYSTEM AND METHOD FOR MOBILE MULTIMEDIA MANAGEMENT

(75) Inventor: Todd M. Porter, Dallas, TX (US)

Correspondence Address: DOCKET CLERK, P.O. DRAWER 800889, DALLAS, TX, 75380, US

(73) Assignee: FotoMage, Inc., Dallas, TX (US)

(21) Appl. No.: 12/473,985

(22) Filed: May 28, 2009

Related U.S. Application Data
(60) Provisional application No. 61/130,096, filed on May 28, 2008.

(51) Int. Cl. G06F 15/16

(52) U.S. Cl. 709/203; 709/237; 709/217; 709/219; 715/810

(57) ABSTRACT

A system and method for mobile media management is provided. In some embodiments, the system and method comprises a first menu that prompts a user to enter information associated with two or more members and a management server configured to receive the information from the user. The management server also is configured to receive a media content from the user and automatically determine if the media content is associated with a member based on the information received from the user. The system and method further comprises a memory component configured to store the media content to a memory based on the member determined to be associated with the media content, and a second menu that allows the user to search the memory for the media content associated with the member by selecting the member.

In other embodiments, the system and method comprises a management server configured to receive a plurality of multimedia content from a user and automatically organize the plurality of multimedia content based on two or more categories. The system further comprises a menu that allows the user to select at least one of the two or more categories, wherein only the multimedia content that corresponds to a selected category is downloaded to a media device of the user.

A media device capable of utilizing a menu to select one or more of a plurality of subsets of multimedia content stored on a management server also is provided. In some embodiments, the selected multimedia content comprises two or more photos. The media device further is capable of receiving only the selected multimedia content, and displaying a first photo of the selected multimedia content on a display of the media device while a second photo is being downloaded to the media device.

### CROSS-REFERENCE TO RELATED APPLICATION(S) AND CLAIM OF PRIORITY

The present application is related to U.S. Provisional Patent No. 61/130,096, filed May 28, 2008, entitled “SYSTEM AND METHOD FOR MOBILE MULTIMEDIA MANAGEMENT”. Provisional Patent No. 61/130,096 is assigned to the assignee of the present application and is hereby incorporated by reference into the present application as if fully set forth herein. The present application hereby claims priority under 35 U.S.C. §119(e) to U.S. Provisional Patent No. 61/130,096.

### TECHNICAL FIELD

This disclosure relates generally to multimedia content and, more specifically, to an apparatus and method for managing multimedia content.

### BACKGROUND

With the proliferation of mobile camera phones, digital cameras and video cameras, consumers of these devices are generating a large quantity of photographs and video content. However, these consumers face a challenging task when they want to transfer, print, download and otherwise access and manage various digital media content. Media content captured by digital cameras, camcorders, and the like are often at risk of being accidentally erased or lost (e.g., when a camera or its memory card malfunctions). Today, there is no easy way to manage, archive, make prints, make CD/DVD copies, and share captured digital multimedia content.

### SUMMARY OF THE INVENTION

A method comprising receiving an automatically-initiated media content transfer from a consumer device, and identifying the owner of the transferred media content. The method further comprises determining if the media content is associated with a member based on the information received from the owner of the content, and storing the transferred media content to a memory based on the member determined to be associated with the media content.

A system comprising a first menu that prompts a user to enter information associated with two or more members and a management server configured to receive the information from the user. The management server also is configured to receive a media content from the user and automatically determine if the media content is associated with a member based on the information received from the user. The system further comprises a memory component configured to store the media content to a memory based on the member determined to be associated with the media content, and a second menu that allows the user to search the memory for the media content associated with the member by selecting the member.

A method comprising receiving a plurality of multimedia content, and automatically organizing the plurality of multimedia content according to two or more categories. The method further comprises utilizing a menu that allows a user to select at least one of the two or more categories, and downloading to the media device of the user only the multimedia content that corresponds to the selected categories.

A system comprising a management server configured to receive a plurality of multimedia content from a user and automatically organize the plurality of multimedia content based on two or more categories. The system further comprises a menu that allows the user to select at least one of the two or more categories, wherein only the multimedia content that corresponds to a selected category is downloaded to a media device of the user.

A media device capable of utilizing a menu to select one or more of a plurality of subsets of multimedia content stored on a management server, the selected multimedia content comprising two or more photos. The media device further is capable of receiving only the selected multimedia content, and displaying a first photo of the selected multimedia content on a display of the media device while a second photo is being downloaded to the media device.

### BRIEF DESCRIPTION OF THE DRAWINGS

For a more complete understanding of this disclosure, reference is now made to the following description, taken in conjunction with the accompanying drawings, in which:

FIG. 1 is a simplified schematic diagram of a system for mobile multimedia management according to an embodiment of this disclosure;

FIG. 2 is a simplified block diagram of a mobile device operable to acquire multimedia content according to an embodiment of this disclosure;

FIG. 3 is a simplified block diagram of a device operable to acquire multimedia content retrofitted with a custom chip or chipset with memory, wireless communication, and operating system functionality for mobile multimedia management according to an embodiment of this disclosure;

FIG. 4 is a diagrammatic representation of a media repository table of the media repository depicted in FIG. 1 that facilitates management of media content according to an embodiment of this disclosure;

FIG. 5 is a diagrammatic representation of an entry of a distribution list that facilitates media synchronization according to an embodiment of this disclosure;

FIG. 6A is an exemplary message flow diagram of a system and method for mobile multimedia management implemented according to an embodiment of this disclosure;

FIG. 6B is an exemplary message flow diagram of a media content distribution routine implemented according to an embodiment of this disclosure;

FIG. 7 is a flowchart depicting an upload routine that may be executed by a management server for storing content uploaded by media devices according to an embodiment of this disclosure;

FIG. 8 is a flowchart that depicts processing of a synchronization routine for distributing media content to media devices according to an embodiment of this disclosure;

FIG. 9 is an illustration of an icon for launching a system for mobile multimedia management according to an embodiment of this disclosure;

FIG. 10 is an illustration of an interface that allows a user to enter a user name and password according to an embodiment of this disclosure;

FIG. 11 is an illustration of a list of available groups according to an embodiment of this disclosure;

FIG. 12 is an illustration of a menu that allows a user to play an existing video or explore photos according to an embodiment of this disclosure;

FIG. 13 is an illustration of a list of videos when the video option is selected according to an embodiment of this disclosure;

FIG. 14 is an illustration of a menu for selecting photos according to five of categories according to an embodiment of this disclosure;

FIG. 15 is an illustration of a menu for selecting photos when the Occasions category is selected according to an embodiment of this disclosure;

FIG. 16 is an illustration of a menu for selecting photos when the Date category is selected according to an embodiment of this disclosure;

FIG. 17 is an illustration of a menu for selecting photos when the Location category is selected according to an embodiment of this disclosure;

FIG. 18 is an illustration of a menu for selecting photos when the Participants category is selected according to an embodiment of this disclosure;

FIG. 19 is an illustration of a menu for selecting photos according to their rated quality when the Rate category is selected according to an embodiment of this disclosure; and

FIG. 20 is an illustration of a menu for viewing photos as video, still photos, or in a pan-and-zoom mode according to an embodiment of this disclosure;

FIG. 21 is a flowchart that depicts a method of operating a management server according to an embodiment of this disclosure;

FIG. 22 is a flowchart that depicts a method of operating a management server according to another embodiment of this disclosure; and

FIG. 23 is a flowchart that depicts a method of selecting and viewing multimedia content according to an embodiment of this disclosure.

### DETAILED DESCRIPTION

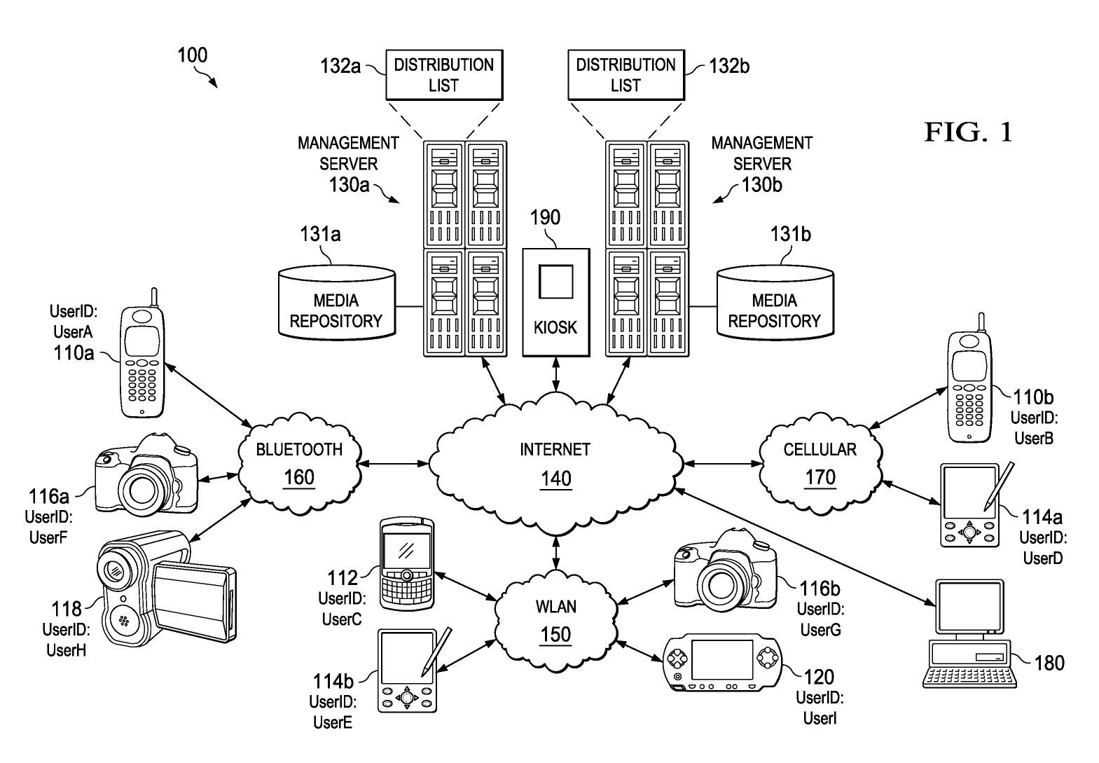

FIGS. 1 through 23, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 is a simplified schematic diagram of an embodiment of a system 100 for mobile multimedia management according to an embodiment of this disclosure. The embodiment of the system 100 shown in FIG. 1 is for illustration only. Other embodiments of the system 100 could be used without departing from the scope of this disclosure.

System 100 enables a variety of different consumer devices to be able to transfer, view, download, upload, and synchronize media content. Consumer devices that may include functionality to capture media content include, for example, mobile phones 110a-110b, smart phones 112, personal digital assistants (PDAs) 114a-114b, digital cameras 116a-116b, digital video cameras 118, personal gaming devices 120, such as the PlayStation™ portable (PSP™), etc. (collectively referred to herein as mobile media devices). Users of media devices may have a user identifier (UserID) or other identifier associated therewith. In the illustrative example, users of devices 110a-120 have a respective UserID of UserA-UserI. These mobile media devices may be in communication with a management server 130a-130b (collectively referred to as management server 130) via, for example, the Internet 140 and/or some other network mechanisms, such as a wireless local area network (WLAN) 150 that may comprise a WiFi network, a Bluetooth network 160 or other personal area network, a cellular network 170 or another mobile network, or another suitable communications system.

Management servers 130a-130b may include or interface with a media content repository 131a-131b (collectively referred to herein as content repository 131). Content repository 131 may comprise a database or other suitable data structure maintained on a storage medium, such as a hard disk, in which media content uploaded to management server 130 from one or more various media devices is stored. Additionally, content repository 131 may include timestamps assigned to media content that is stored thereby to facilitate synchronization between various devices as described more fully hereinbelow. Management servers 130 also may include or interface with a distribution list 132a-132b (collectively referred to as a distribution list 132). Distribution list 132 may include an identifier of a media device, or a user thereof, and other users with whom the user of the media device wishes to share media content.

The consumer devices may be operable to connect to Internet 140 via multiple wireless communications mechanism, and the one with the most available bandwidth and/or fastest speed may be selected for a data transfer session. In other embodiments, a consumer device may directly connect with Internet 140, e.g., via an Internet service provider. In some embodiments, the media devices may be in communication with a computing device 180 such as a computer that may be used to output prints, burn CD/DVD, and perform other tasks. The users of the system may be identified by unique IDs, such as a user name, device ID, device MAC address, and/or other identifiers, and communication sessions and transferred content may be marked or otherwise identified with a user. Security mechanisms are in place to provide only authorized users access to the media content of a user. Passwords and other mechanisms may be used.

The system also may include a kiosk 190. Kiosk 190 may provide an interface with a consumer located at various locations, such as retail locations, airports, hotels, resorts, amusement parks, or other convenient locations. Kiosk 190 may include a computing device, a display screen that may be touch-sensitive and user input devices such as a keyboard, pointing device, etc. Kiosk 190 may have a reader that accepts a variety of memory flash cards to quickly transfer captured media content therein to an internal memory of kiosk 190. The transferred content may be marked with user identification information that has been encoded on the memory flash card so that the multimedia content may then be uploaded to a management server 130. The user also may use an identification card with a computer-readable code such as a bar code, a magnetic strip, a smart chip or some other device that enables kiosk 190 to label or mark the transferred content as belonging to a specific user account. Kiosk 190 may be used in areas where cellular service is spotty and other wireless LAN service is absent or limited.

System 100 may include a phone-resident photo/video manager which has the ability to automatically communicate, synchronize and deliver digital media content to a management server 130, and the ability to enable users to view photos/videos off management server 130. System 100 also may include a computing device-resident photo/video manager that has the ability to automatically communicate, synchronize and deliver digital media content to management server 130, and the ability to view photos/videos off management server 130. Multimedia content downloaded to the computing device 180 (e.g., a PC, workstation, laptop, server, or other suitable device) may be printed, copied onto CD/DVD, edited, or otherwise manipulated and processed. Similarly, media content imported (e.g., from a camera, video camera, scanner, CD, DVD, or the Internet) onto computing device 180 may be uploaded to management server 130 and/or output in a number of print or digital formats. The phone-resident manager and the computing device-resident manager enable a synchronization or download of digital media content stored on management server 130 to the respective devices. A synchronization process is operable to compare various media content at management server 130 to the content stored at a computer, for example, and to synchronize the two so that the content mirror each other. A download may be made with respect to certain particular media files, timestamp of the media files, or some other method of specifying a subset of media content to transfer to the device, such as a mobile phone or PSP™. The upload, download and synchronization are performed automatically and transparently without user initiation or request. Multiple management servers 130a-130b may be deployed in clusters in order to service all consumers needs and/or to provide for fault tolerance. Further, management servers 130 may have one or more mirrored management servers that serve as backup storage copies of an active management server.

Therefore, photos, videos, or other media content may be automatically duplicated onto management server 130. In one embodiment, if a media capture device such as a mobile phone is off, when it is turned back on, management server 130 may automatically be called and media content transfers may then be made. The user may select to automatically delete media content once transfer is made to free up memory on the capture device. Media content may be stream-viewed on a capture device, and media content may be downloaded and viewed on the mobile phone. All media content may be archived on management server 130.

System 100 may provide various benefits to users. For example, users are provided with a seamless way to transfer their media content to and from their media capture devices, and system 100 provides users with a secure storage place for their media content. Additionally, users have access to their entire collection of media content on-the-go. For example, existing mobile phones with media content capture functionality may have a phone-resident management client added, and existing mobile phones and PCs may receive or otherwise obtain a client to access media content stored on management server 130.

System 100 may include additional servers, clients, and other devices not shown. In the depicted example, Internet 140 represents a worldwide collection of networks and gateways that use the Transmission Control Protocol/Internet Protocol (TCP/IP) suite of protocols to communicate with one another. FIG. 1 is intended as an example, and not as an architectural limitation, of a network system in which embodiments disclosed herein may be deployed.

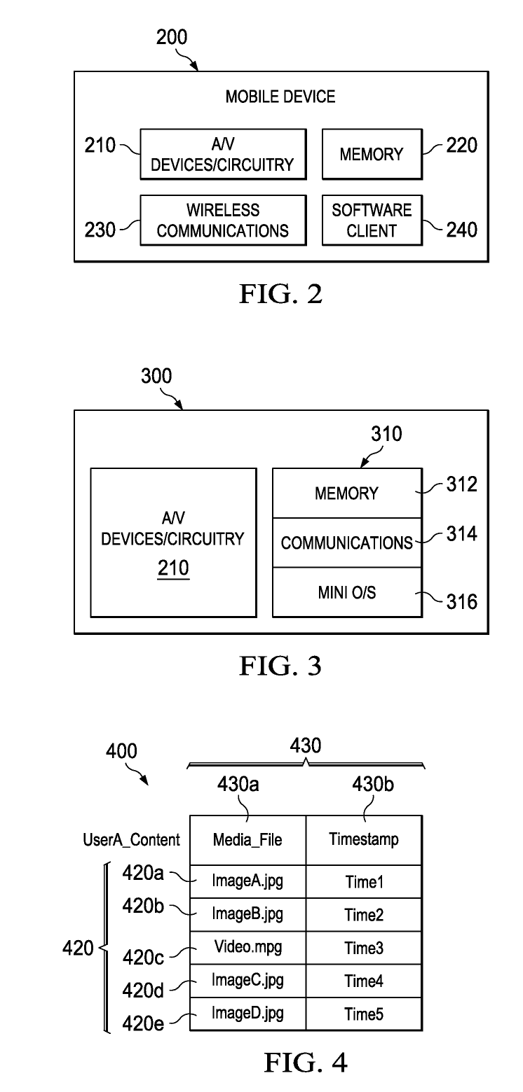

FIG. 2 is a simplified block diagram of an embodiment of a mobile device 200 operable to acquire media content. For example, mobile device 200 may be a mobile phone 110a-110b, smart phone 112 equipped with a camera, PDA 114a-114b, video camera 118, or other device adapted to capture media content. Mobile device 200 may comprise audio/video capture and/or playback devices and circuitry 210, such as digital camera/video optical devices and circuitry for capturing still and/or video images, a memory device 220 for storing captured images or other media content, and wireless communication module 230 that may include hardware, firmware, software, or a combination thereof. Additionally, mobile device 200 may include a software thin client 240 that includes phone-resident management software that enables the content captured by mobile device 200 to be automatically uploaded to management server 130. In accordance with an embodiment, the user of device 200 will not need to initiate the upload process, but rather the upload process may be invoked automatically. In one embodiment, as soon as new media content is discovered in the device's memory, the upload of the new media content is initiated. Mobile device 200 also may automatically synchronize with management server 130 or instruct management server 130 to download particular media content.

FIG. 3 is a simplified block diagram of an embodiment of a device 300 retrofitted with a custom chip or chipset 310 with memory 312, a wireless communication module 314 comprising hardware, firmware, software, or a combination thereof, and an operating system 316 for general device hardware and software management and mobile media management. Device 300 is operable to acquire media content in accordance with embodiments disclosed herein. Device 300 may comprise a digital camera, a digital video recorder, or some other device that is not manufactured with wireless communication capabilities, but rather is adapted with wire communication capabilities via retrofitting device 300 with chipset 310. The custom chip or chipset 310 may be a replacement of a memory card used in mobile device 300 or may be incorporated into an existing mobile device in some other manner. The mini operating system (O/S) 316 may manage media content on device 300, automatically initiate content upload, download and synchronization with management server 130, and other functions. Alternatively, media management functionality may be provided by an application running on O/S 316.

FIG. 4 is a diagrammatic representation of a media repository table 400 of media repository 131 depicted in FIG. 1 that facilitates management of media content in accordance with an embodiment of this disclosure. Table 400 records identifiers, such as file names, of content captured by a media device and uploaded to management server 130 with timestamp data. Additionally, table 400 may associate an identifier of the user that uploaded the content identified by table 400.

In the illustrative example, table 400 comprises a plurality of records 420a-420e (collectively referred to as records 420) and fields 430a-430b (collectively referred to as fields 430) in which media content identifiers uploaded from a device associated with a particular user is stored. Table 400 may be stored on a disk drive or other suitable medium, fetched therefrom by a processor or other instruction processing device, and processed by a data processing system, such as management server 130 depicted in FIG. 1.

Table 400 may have a label or identifier, such as a file name, that facilitates media management implemented in accordance with an embodiment of this disclosure. In an illustrative example, table 400 has a label of UserA_Content. Thus, table 400 is representative of a data structure that may maintain records of media content uploaded by phone 110a associated with a user having a UserID of UserA.

Fields 430 have a respective label or identifier that facilitates insertion, deletion, querying, or other data operations or manipulations of content thereof. In the illustrative example, fields 430a-430b have respective labels of Media_File and Timestamp. Each record 420a-420e defines a respective media content file identifier (e.g., filename) and a corresponding timestamp at which a media content specified in field 430a of a corresponding record of table 400 was uploaded to management server 130.

In the illustrative example, data elements stored in Media_File field 430a comprise media identifiers of a particular media content uploaded to management server 130 from a device associated with the user having a UserID of UserA. Data elements of Media_File field 430a may, for example, specify an image file name, a multimedia file name, an audio file stream, or the like. In this example, Media_File labels of media content uploaded to management server 130 by the user having a userID of UserA are illustratively designated ImageA.jpg, ImageB.jpg, VideoA.mpg, ImageC.jpg, and ImageD.jpg. Timestamp field 430b comprises timestamps that specify a time at which a media file identified by Media_File field 430a of a corresponding record were uploaded from a media device to management server 130. In this example, the times at which media files identified in Media_File field 430a were uploaded to management server 130 are illustratively designated Time1-Time5. Data structures similar to that depicted in FIG. 4 may be maintained or interfaced by management server 130 for other users that have uploaded media content to management server 130.

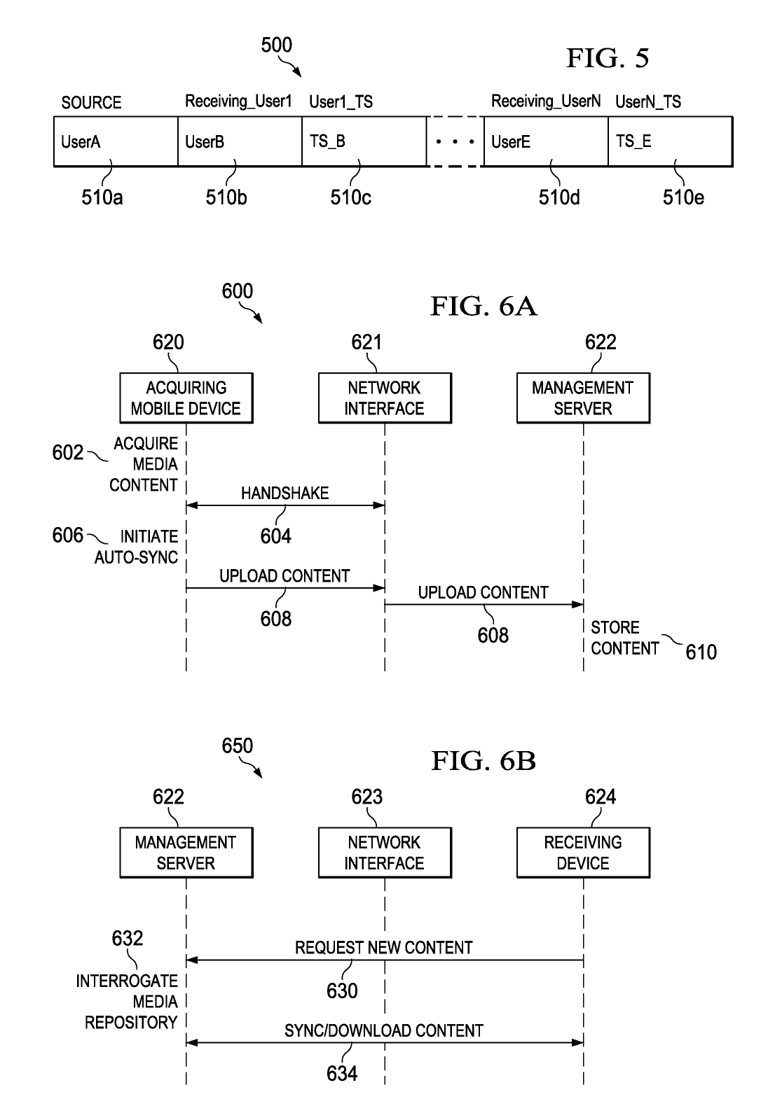

FIG. 5 is a diagrammatic representation of an entry 500 of distribution list 132 depicted in FIG. 1 that facilitates media synchronization in accordance with an embodiment of this disclosure. Entry 500 associates user identifiers of users with whom a source user wishes to share media content in accordance with embodiments of this disclosure. Additionally, entry 500 may associate timestamp data with users to indicate a most recent synchronization of a device associated with the respective user.

In one embodiment, entry 500 comprises a record with various fields 510a-510e (collectively referred to as fields 510). Entry 500 defines a distribution list of users that may have media content synchronized with another user. Entry 500 may be stored on a disk drive or other suitable medium, fetched therefrom by a processor or other instruction processing device, and processed by a data processing system such as management server 130 depicted in FIG. 1. Distribution list 132 may have a plurality of entries similar to entry 500 each allocated for a particular user. For example, distribution list 132 may be implemented as a table with distribution list entries maintained as records thereof.

Fields 510 have a respective label that facilitates insertion, deletion, querying, or other data operations or manipulations of content thereof. In the illustrative example, fields 510a-510e have respective labels of Source, Receiving_User1, User1_TS, Receiving_UserN, and UserN_TS. Entry 500 defines a distribution list of a particular source or user specified in Source field 510a. Thus, in this embodiment, entry 500 defines a distribution list for the user having a UserID of UserA (i.e., the user assigned to phone 110a depicted in FIG. 1).

In this embodiment, one or more fields 510b and 510d may specify a respective user that may be allowed to synchronize media content captured and uploaded to management server 130 by the source user specified in Source field 510a. In this embodiment, fields 510b and 510d specify users having respective UserIDs of UserB and UserE that may be allowed to obtain and synchronize media content captured and uploaded by the user having a UserID of UserA specified in Source field 510a.

Each field identifying a particular user that may download media content uploaded by the source user specified in entry 500 may have an accompanying timestamp that specifies the most recent, if any, time at which the user downloaded the media content uploaded by the source user. In this embodiment, fields 510c and 510e specify timestamps illustratively designated TS_B and TS_E thereby indicating that the most recent time at which the users having UserIDs UserB and UserE downloaded content provided by the user UserA was at a time “TS_B” and “TS_E”, respectively. The timestamp values specified by the timestamps in fields 510c and 510e may specify a date including the year, month, and day, and a time at which the most recent download was made by the associated user. Thus, entry 500 specifies that media content uploaded by the user UserA may be downloaded by the users having UserIDs of UserB and UserE. Of course, the source user also may download content uploaded thereby.

FIG. 6A is an exemplary message flow diagram 600 of a system and method for mobile media management implemented in accordance with an embodiment of this disclosure. Message flow diagram 600 depicts an exemplary routine for automatically uploading acquired content by, for example, a mobile device adapted to capture media content.

The routine may be invoked upon the acquisition of media content (step 602) (e.g., such as acquisition of one or more pictures, video, audio, or other media content) by an acquiring mobile device 620. A device-resident media manager (e.g., a photo/video manager) may detect the acquisition of the media content and invoke a handshake routine over a network interface 621 (step 604). Network interface 621 may, for example, comprise a Bluetooth interface, a cellular network interface, or other wireless network interface. Upon completion of the handshake, an auto-synchronization routine may be initiated (step 606), and the newly acquired media content may then be uploaded to a management server 622 (step 608), such as management server 130 depicted in FIG. 1. Uploading of the media content may be made via one or more wireless networks, such as a WiFi network, cellular network, or other suitable wireless network infrastructure, and may be conveyed from the wireless network to management server 622 by Internet 140. Upon receipt of the uploaded content by management server 622, management server 622 may store the content (step 610).

In one embodiment, the acquiring device 620 may include an identifier (e.g., of a user associated with device or a device identifier assigned to device 620) that may be used to associate the particular user with the acquired content. Accordingly, management server 622 may store the uploaded media content in association with the user identifier or a device identifier from which a user assigned to the acquiring device may be resolved.

FIG. 6B is an exemplary message flow diagram 650 of a media content distribution routine implemented in accordance with an embodiment of this disclosure. Message flow diagram 650 depicts an exemplary routine for distributing content acquired by a mobile device to other devices.

A receiving device 624, such as a mobile phone, PDA, computing device, or other data processing system, may issue a request for new content from management server 622 (step 630). The request may be conveyed over a suitable network interface 623, such as an interface with a cellular network, WiFi network, or other suitable medium, and may be conveyed therefrom via Internet 140 to management server 622. In one embodiment, the request may include an identifier associated with the user of the receiving device 624. Additionally, the request may include an identifier of the media content, if any, currently maintained by receiving device 624. In another embodiment, the receiving device 624 may include a timestamp that indicates the most recent time receiving device 624 has been provided with media content. Management server 622 may interrogate a media content repository with the user identifier associated with receiving device 624 to determine any users with whom the user of device 624 is associated (step 632). Upon determining that the user of receiving device 624 is associated with an acquiring device that has provided content to management server 622, management server 622 may resolve the particular content to be delivered to receiving device 624 such that receiving device 624 has the most recent media content acquired by the acquiring device. The media content may then be downloaded to the receiving device 624 (step 634).

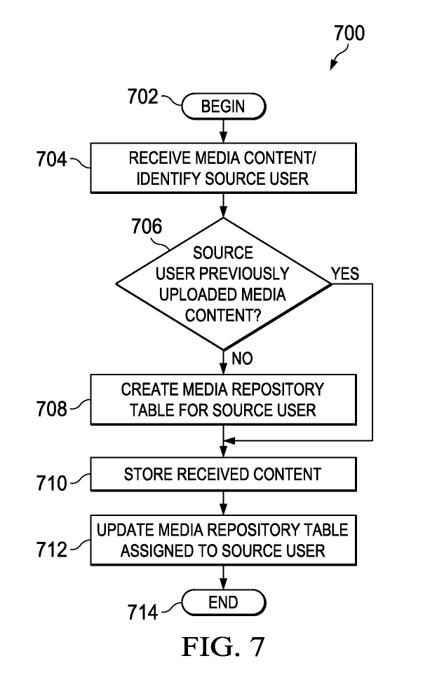

FIG. 7 is a flowchart 700 depicting an upload routine that may be executed by management server 130 for storing content uploaded by media devices in accordance with an embodiment of this disclosure.

The upload routine is invoked (step 702), and the management server receives uploaded media content from a media device (step 704). The media content uploaded by a source media device may have a UserID associated therewith. The management server may then evaluate whether the user of the source device (i.e., the source user) has previously uploaded media content to management server 130 (step 706). In the event that the source user has not previously uploaded media content, the upload routine may then create a media repository table similar to that depicted in FIG. 4 or other suitable data structure for the source user (step 708), and the upload routine may proceed to store the received media content (step 710).

Returning to step 706, in the event that the source user has previously uploaded media content to the management server, the upload routine may proceed to store the received media content according to step 710. The media repository table assigned to the source user may then be updated to reflect the newly uploaded media content (step 712). For example, a new record may be added to the media repository table assigned to the source user that specifies the media content file and may have a timestamp associated therewith indicating the time at which the newly acquired media content was uploaded to management server 130. The upload routine cycle may then end (step 714).

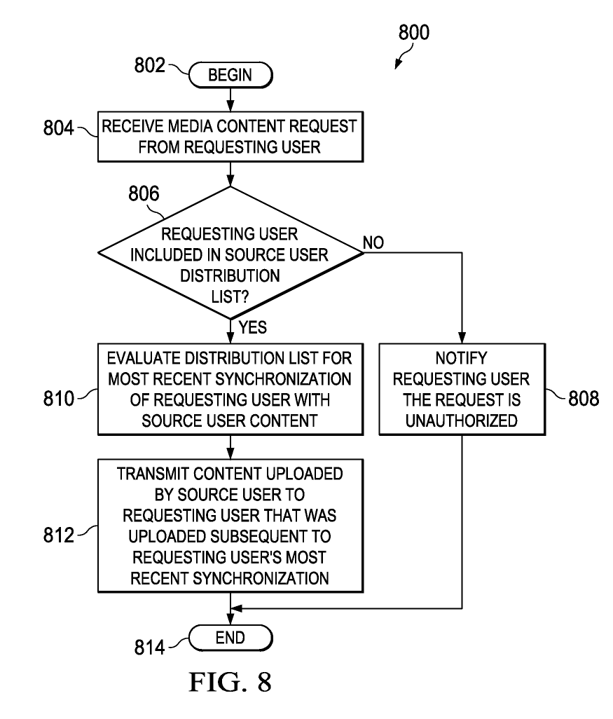

FIG. 8 is a flowchart 800 that depicts processing of a synchronization routine for distributing media content to media devices in accordance with embodiments disclosed herein.

The synchronization routine is invoked (step 802), and a request for media content is received from a requesting or receiving user device (step 804). In one embodiment, the request for media content may include a UserID of a media content source user with whom the requesting user wishes to be synchronized. The synchronization routine may then evaluate whether the requesting user is included in the source user's distribution list (step 806). If the requesting user is not included in the source user's distribution list, a notification that the requesting user is unauthorized to obtain media content uploaded by the source user specified in the request may be transmitted to the requesting user device (step 808), and the synchronization routine cycle may then end (step 814).

Returning to step 806, in the event that the requesting user is included in the distribution list of the source user specified in the media request, the synchronization routine may then evaluate the distribution list of the source user for the most recent synchronization time of the requesting user (step 810). The synchronization routine may then transmit to the requesting user device any content that is identified as having been uploaded by the source user device since the most recent synchronization of the requesting user device (step 812). The synchronization routine cycle may then end according to step 814.

In other embodiments, the request for content issued to management server 130 by a device may not include an identifier of a particular source user. Rather, management server 130 may interrogate distribution list 132 with the requesting UserID to identify any source users that have designated the requesting user as authorized to view the source user's content. In one embodiment, any content uploaded by one or more, if any, source user that have designated the requesting user as authorized to view content uploaded thereby may then be transmitted to the requesting user. Additionally, timestamps of content of any of the one or more source users that have designated the requesting user as authorized to view content uploaded thereby may be evaluated such that only content uploaded since the requesting user's most recent synchronization is transmitted to the requesting user similar to that described with reference to FIG. 8.

Embodiments disclosed herein may better be understood with reference to the following examples. Assume UserA takes pictures with phone 110a. The pictures begin automatically uploading to management server 130 after UserA takes the pictures. Further assume that UserA has designated UserB as a valid receiver of UserA's content. UserB may then turn on phone 110b and login to management server 130 to check for any new pictures acquired by UserA using the phone-resident management software on phone 110b. In this instance, pictures captured from UserA may then be downloaded to phone 110b for viewing by UserB. Other users' content also may be downloaded to phone 110b via management server 130 if UserB is designated as a valid receiver of the other users' content.

UserA may additionally have PC-resident management software on UserA's PC (e.g., computing device 180 depicted in FIG. 1). In this instance, UserA may access management server 130 from computing device 180, download the newly acquired content taken with phone 110a, and, for example, burn a photo CD of the newly acquired pictures, print pictures on a printer connected to computing device 180, or otherwise retrieve and process, at computing device 180, content acquired with phone 110a.

Accordingly, pictures taken by a user may be automatically uploaded to management server 130 for retrieval by the user via other devices that may be located at various locations. Furthermore, distribution of media content acquired by a media device may be made to other users that have been designated as authorized to view the user's media content. In one embodiment, media content may be automatically deleted from a device from which the media content was acquired as soon as the newly acquired content is uploaded to management server 130 thereby freeing up memory.

Some real world use scenarios are especially instructive in describing the functionality of the system. The following activities may take place:
1. Sally takes pictures of her son, Ben, at his soccer game.
2. The pictures begin uploading to the management server the moment she takes them (trickle upload).
3. Sally's mother Kate opens her cell phone and checks with the management server for any new pictures using the phone-resident management software.
4. Pictures arrive from Sally and videos arrive from Ed (Ed is Kate's son) on Kate's cell phone via the management server.
5. Kate views pictures of Ben's soccer game (streamed).
6. Kate views video from Ed who is in Mexico (streamed).
7. Sally goes home and opens the PC-resident management software interface on her PC.
8. Sally burns a DVD of a video she took at the game downloaded from the management server.
9. Sally burns a photo CD of photos she took at the game downloaded from the management server.
10. Sally prints pictures on her printer from the management server.
11. Ed goes home and transfers photos and videos from his camera and camcorder to the management server.
12. Ben connects his PSP™ to his computer and transfers movies of a huge fish his uncle Ed caught on his Mexico trip to his PSP™ via the management server.
13. Sally and Kate see new pictures and video from Ed's trip to Mexico from the management server.
14. Kate walks next door and shows her neighbor pictures of the soccer game, pictures of Ed in Mexico, and video from Mexico—all on her cell phone downloaded from the management server.

Another use case:
1. Don has just bought a mobile multimedia management-enabled digital camera.
2. Don is at Disney world and has taken 45 pictures so far and is eating lunch with his family.
3. As soon as he sets his camera down, it connects either WiFi, Bluetooth, or by cellular to the management server.
4. His pictures upload during lunch.
5. Don picks up his camera and discovers his pictures have been copied, and he now has space back on his memory card.
6. Don's mother runs the PC or phone-resident management software and can view the pictures of her son's family trip to Disney—as it is happening.
7. Don returns home and burns a DVD Slideshow of his trip using pictures downloaded from the management server.
8. Don then prints a few photos by burning them on CD to take to his pharmacy to print.

A third use case:
1. Eric has just bought a mobile multimedia management-enabled digital camcorder.
2. Eric is on a island trip and has filmed his family at a turtle farm.
3. Eric returns to his room and sets down the camcorder that has been uploading his movies to the management server.
4. Eric is out at dinner with his family and runs into friends.
5. Eric pulls out his cell phone and shows them the video he took from the morning trip to the turtle farm.
6. Eric returns from the trip and burns a DVD using video that he took with his camcorder and downloaded from the management server.
7. Eric's wife imports the video to her PDA to show people at work.
8. Eric's son connects his PSP™ and downloads a video of himself petting a turtle to show his friends.

In addition to allowing for the automatic uploading and storage of multimedia storage, the system 100 also solves the problem of quickly organizing large amounts of multimedia content by utilizing member-based technology that allows for rapid, robust tagging of multimedia content.

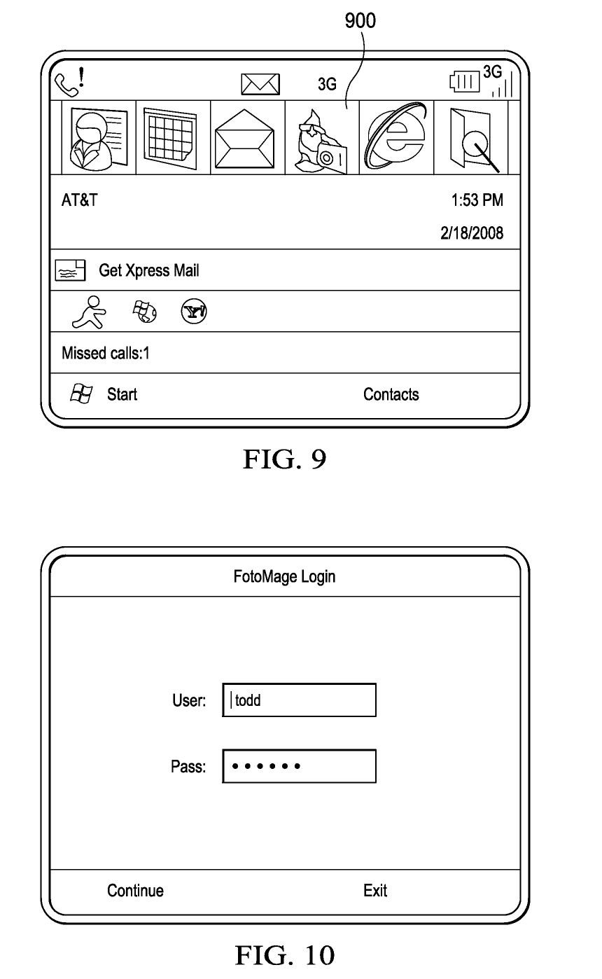

As shown FIG. 9, system 100 is launched by selecting an icon 900 associated with system 100. The user is then presented with an interface that allows the user to enter a user name and password as shown in FIG. 10.

System 100 allows for rapid tagging of multimedia content by taking advantage of the fact that users customarily take photos and videos of their friends and family. Users typically do not take pictures or videos of random people and random events. In order to take advantage of this tendency towards friends and families, system 100 utilizes member-based storage by allowing the user to define a member group (e.g., the user defines their friends and families). In defining a member group, the user also defines hierarchical relationships. For example, the user can define their parents, their siblings, their spouse, and their children. From this information, system 100 constructs a family tree of all the user's relations.

This construction of the user's member group begins when photos are added or uploaded to system 100. For example, when a user adds a photo, the user will define the people in the photo, as well as their relationship to the user. Accordingly, a member group is created and expanded with each photo, and system 100 begins to create a basis for guessing the people and events as new photos are added to system 100. For example, suppose that a user has entered his son's birthday into system 100. If the user uploads photos into system 100 that were taken on a weekend corresponding to the son's birthday, system 100 will guess that the photos were taken of the son's birthday party. Of course, system 100 also can guess based upon holidays, such as Thanksgiving and Christmas. System 100 also can guess looking at the folder name or file name. For example, if the folder is named “Ed's Birthday 2003”, system 100 will look for the name “Ed” in the member group. System 100 also will know that the term “Birthday” corresponds to a holiday, and that “2003” is a calendar date. This is particularly advantageous for analog photos that do not have digital data. The advantage of having system 100 automatically label the photos as they are uploaded is that this allows a user to get data into system 100 as quickly as possible.

System 100 also has the ability to learn from previous events. For example, if a user traditionally takes a summer vacation to the beach every summer, system 100 will assume that a spike in the number of pictures uploaded to system 100 during the summer corresponds to a vacation at the beach and will label the photos as such. Of course, if system 100 makes an incorrect assumption and incorrectly labels the photos, the user can always go back and change the label for the entire group of photos or for each photo individually.

Another heuristic ability of system 100 is to make a guess according to the mobile device that took the photo. For example, unless an uploaded photo corresponds to an event or holiday, system 100 may assume that the photo was taken in the city that the user resides. System 100 also may take advantage of GPS data to label the photos according to the location at which they were taken.

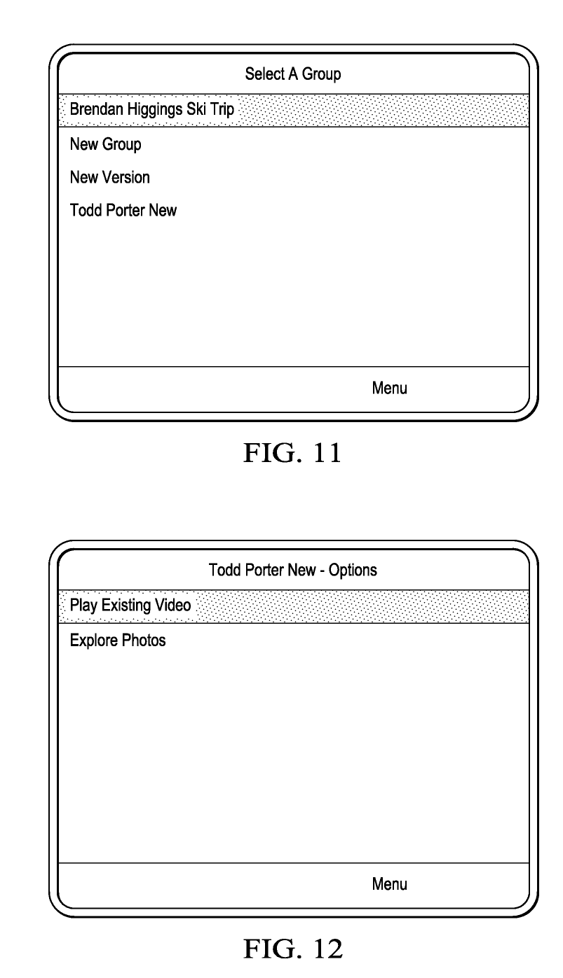

Once the user has logged into system 100 as shown in FIG. 10, the user will be shown a list of available groups as shown in FIG. 11. The groups allow users to separate their photos by interest, such as sports, travel, and family.

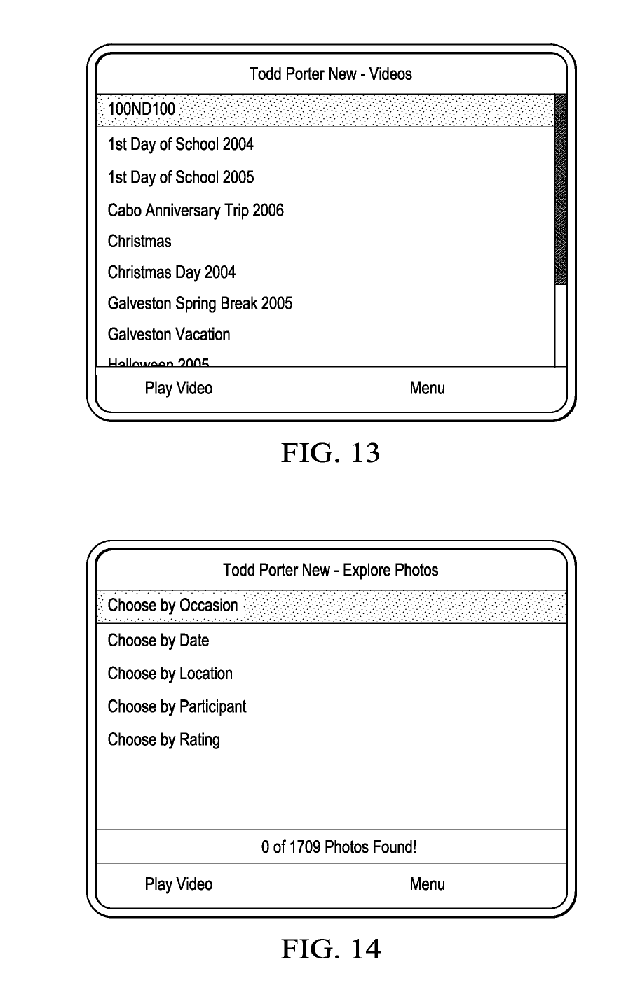

As shown in FIG. 12, system 100 also allows the user to play an existing video or explore the photos. If an existing video is selected, a list of videos that the user has created is displayed as shown in FIG. 13.

In addition to organizing the multimedia content, system 100 also solves the prominent problem associated with folder-based methodologies for mobile devices which is the speed of the delivery of data. For example, even if a user were to utilize thumbnails to view all of the photos on their mobile device, there is still a significant delay in the delivery of the thumbnails.

System 100 does not require a user to sort through photos by viewing each and every picture, eliminating the use and download of thumbnails. Instead, a user can decide which pictures they want to view by communicating to system 100 that they want to view photos pertaining, for example, to a particular occasion or person without having to view all of the other photos. As shown in FIG. 14, if a user selects the explore photos option, a menu appears that allows the user to select photos according to five categories: Occasion, Date, Location, Participant, and Rating.

Accordingly, system 100 provides a user with an interface that allows the user to narrow the number of photos that they want to view using these five categories before system 100 starts delivering them to the user's mobile device.

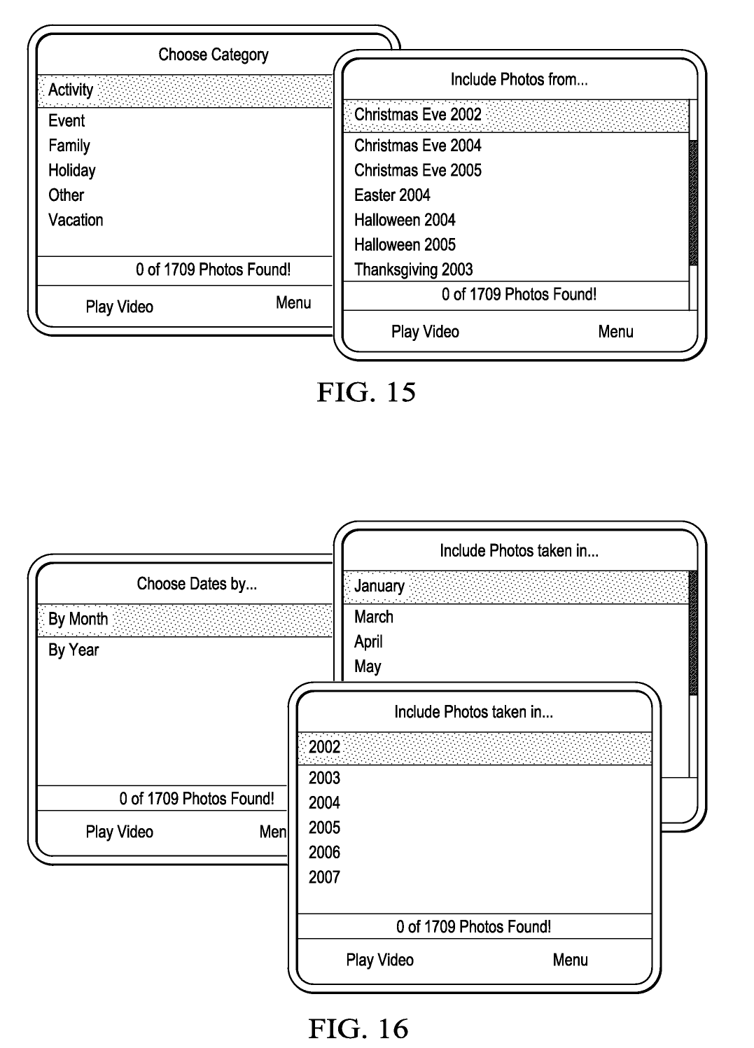

As shown in FIG. 15, if the Occasions category is selected, another menu appears allowing the user to select from different sub-categories, such as Activity, Event, Family, Holiday, Other, and Vacation. These sub-categories are broken down into further sub-categories. For example, under Holidays, Christmas Eve, Easter, Halloween, and Thanksgiving are listed.

As shown in FIG. 16, if the Date category is selected, the photos can be selected according to month and year.

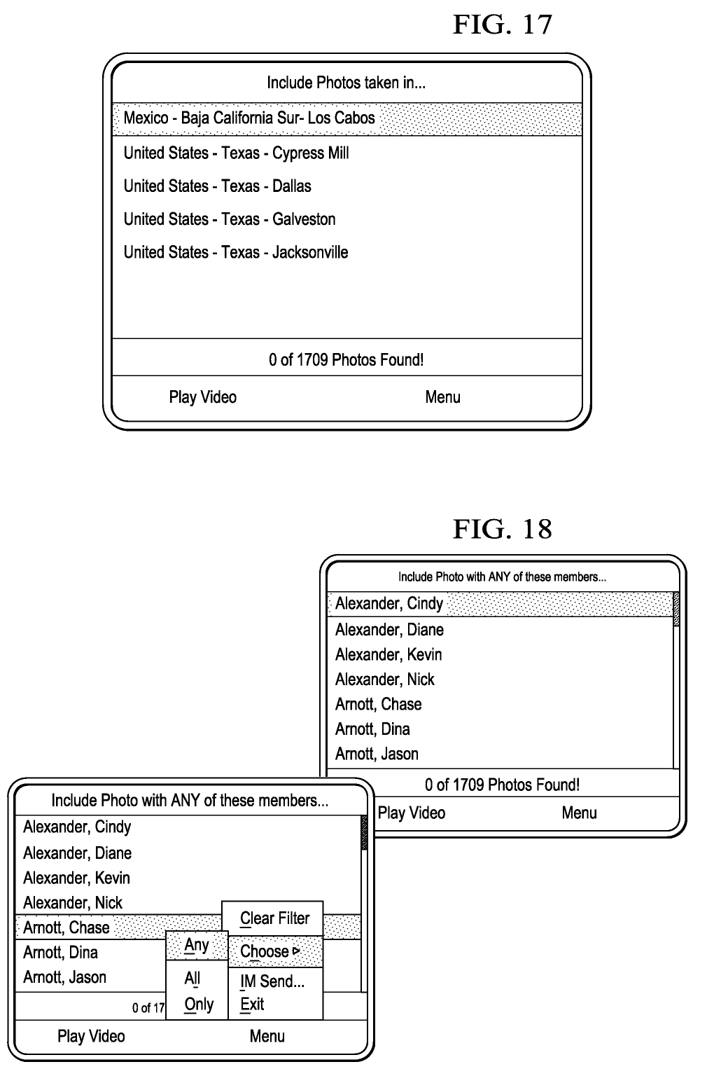

As shown in FIG. 17, if the Location category is selected, the photos can be selected according to the location that they were taken.

As shown in FIG. 18, if the Participants category is selected, a list of all the participants in the photos on system 100 is shown. The user can then select photos according one or more participants.

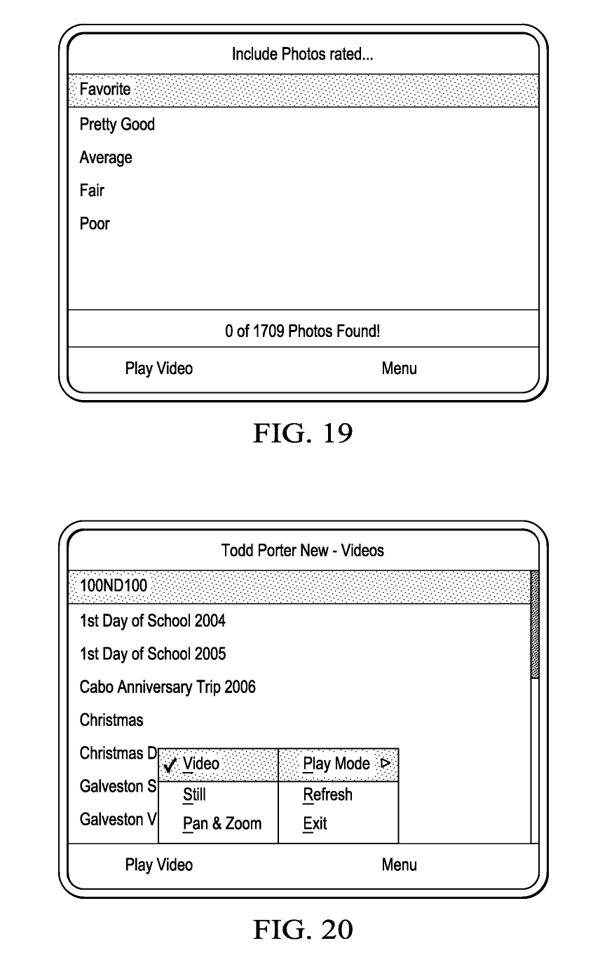

As shown in FIG. 19, if the Rate category is selected, the user can select photos according to their rated quality.

Each of these categories serve as a filter to reduce the number of photos that will be delivered to the mobile device. As an example, suppose a user has 10,000 photos on system 100. That user can first narrow the photos down to a particular person or persons (for example, their best friend). System 100 would then inform the user that this criteria narrowed the number of photos down to 200 photos. From those 200 photos, the user may only want the photos corresponding to New Year's eve 2000. System 100 would then inform the user that this criteria narrowed the number of photos down to 30 photos. From those 30 photos, the user may select only the photos that have a rating of four or better, for example. System 100 would then inform the user that this criteria narrowed the number of pictures down to 10 photos that the user will eventually download. Accordingly, rather than downloading 10,000 thumbnails to find the photos of the user's best friend on New Year's eve 2000. The user only downloaded 10 photos. This conserves bandwidth, as well as memory, which are important considerations given the limited bandwidth and memory capacity of mobile devices. Of course, if any of the narrowing criteria result in no photos being found, the user can always go back and unselect the criteria.

This narrowing is accomplished using selectable menus as opposed to the user typing in any data, which is particularly useful for mobile devices that do not have keyboards such as wireless picture frames. Of course, the selectable menus can be customized by the user. As show in FIG. 15, for example, the Occasions category can be organized into subcategories such as Activity, Event, Family, Holiday, Other, and Vacation. Under the Holiday sub-category, for example, would be would be holidays such as Christmas, Easter, Halloween, and Thanksgiving.

Accordingly, some of the limitations overcome by system 100 include:

eliminating the use of thumbnails which are difficult to view on portable devices because of their small size;

eliminating the download of a large number of photos onto a mobile device with limited bandwidth and memory;

eliminating the need to type on a mobile device by implementing selection through menus; and

eliminating the need to know anything about a person's data because the photos are organized for the user.

Once the photos are uploaded and organized, system 100 allows for the delivery of the selected photos to a mobile device of limited bandwidth and storage. Although the limited bandwidth and storage of mobile devices can be overcome by the use of slideshows in a movie format, the use slideshows has the following disadvantages:

slideshows result in small images. For example, 3 GP limits a user to a 160:120 image;

slideshows require a sustained bandwidth to download the images. For example, a 3 GP file downloads at 15 frames/second. Therefore, if a mobile device drops down to 12 frames/second, a user will not get the desired quality;

slideshows result in a canned experience in that a person receiving a slideshow cannot modify the slideshow; and

slideshows also require the person sending the slideshow to go through several steps and input numerous information.

System 100 overcomes these limitations by delivering the photos:

in as high resolution format as possible;

with audio; and

in a format that allows the user to modify the photos so that the delivery is not a canned experience.

The canned experience is eliminated by allowing the user to explore and select photos to create a movie.

Also, applying movement to a photo by panning and zooming results in a Ken Burns effect. This gives the user a virtual higher resolution of the photo. Every photo will be displayed, for example, from 4 to 6 seconds. Therefore, instead of having to download 15 frames/second, system 100 only has to download one frame every 4 to 6 seconds. Furthermore, because only a few photos need to be stored at any time, a circular buffer can be utilized to cache a small number of photos to get ahead. Accordingly, system 100 only needs to have one photo automatically downloading in the background as each photo is being presented. This allows system 100 to download high resolution photos and show them, for example, in a 320:240 format as opposed to a 160:120 format. Moreover, the photo itself may be downloaded in a 640:480 format.

Once added, the photos in system 100 may be viewed, for example, as a video, still photos, or in a pan-and-zoom mode, which is blend of still photos and movies. This selection menu is shown in FIG. 20.

Furthermore, because system 100 is not dependent on a particular codec, a user does not have to have a specific codec on their mobile device. Another advantage is that audio is decoupled from video. Therefore, localization issues are not present, and users can stream different audio files (for example, a music file as well as a voice-over file). System 100 allows a user to set the level of security per photo or per folder. Moreover, a person may be granted access to certain photos or folders depending upon the password that they are given by the user, and that person will not be aware of the existence of the other photos.

Also, with system 100, a user can allow access to their photos simply by dropping a widget on a web page such MySpace® or Facebook®.

Another advantage is that the photos delivered by system 100 do not need to be pulled from system 100. A referential access to a photo on another site can be used instead. For example, a user may have access to photos on Kodak EasyShare® or Picasa® that they want to include in their movie. System 100 can access the sites using the user's password, grab the desired photos, and add them to a movie in realtime without the user even knowing. This is possible because when a person first imports a photo into system 100, they are given the option of importing the photo as a copy or as a reference. A reference will not take up any room on system 100, but any changes to the photo will be saved locally on system 100. Also, when a user is on a picture, system 100 allows the user to click a button and see information regarding the picture.

Accordingly, system 100 provides a virtual universal interface to all photo sites using referential points to the data on the sites. The user just has to create and store the data one time, and the bullet appears in all the different locations so that a user can access the data. The user no longer has to be concerned about which sites are supported by a particular hardware.

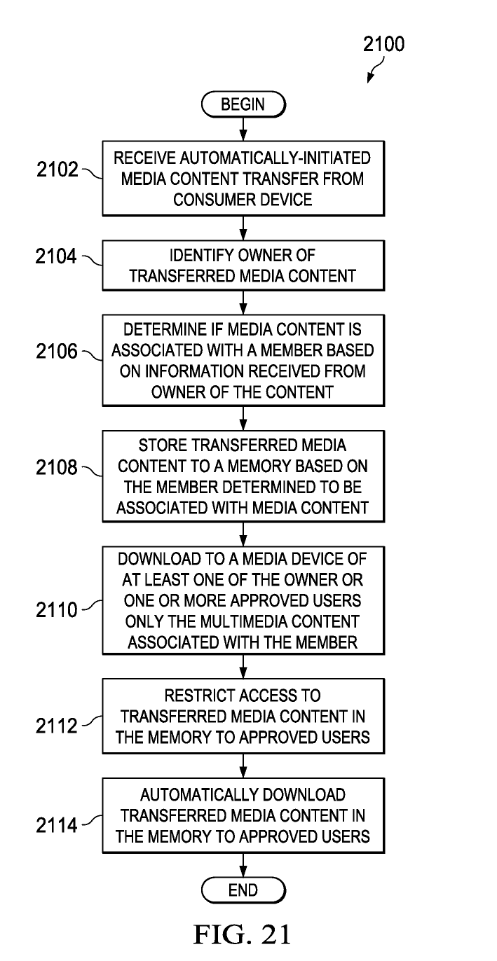

FIG. 21 is a flowchart that depicts a method of operating a management server according to an embodiment of this disclosure. The method begins when a management server receives an automatically-initiated media content transfer from a consumer device (step 2102). The management server then identifies the owner of the transferred media content (step 2104), and determines if the media content is associated with a member based on the information received from the owner of the content (step 2106). The management server then stores the transferred media content to a memory based on the member determined to be associated with the media content (step 2108).

In some embodiments, the management server downloads to a media device of at least one of the owner or one or more approved users only the multimedia content associated with the member (step 2110). The management server also restricts access to the transferred media content in the memory to approved users (step 2112), and automatically downloads the transferred media content in the memory to approved users (step 2114).

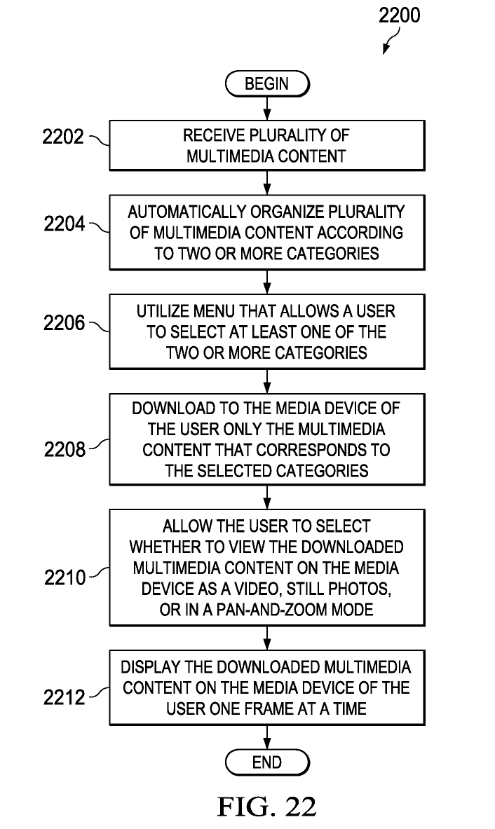

FIG. 22 is a flowchart that depicts a method of operating a management server according to another embodiment of this disclosure. The method begins when the management server receives a plurality of multimedia content (step 2202), and automatically organizes the plurality of multimedia content according to two or more categories (step 2204). The management server then utilizes a menu that allows a user to select at least one of the two or more categories (step 2206), and downloads to the media device of the user only the multimedia content that corresponds to the selected categories (step 2208).

In some embodiments, the management server allows the user to select whether to view the downloaded multimedia content on the media device as a video, still photos, or in a pan-and-zoom mode (step 2210), and displays the downloaded multimedia content on the media device of the user one frame at a time (step 2212).

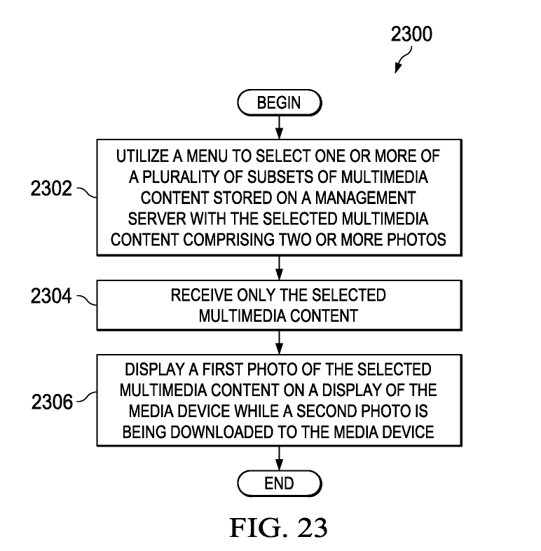

FIG. 23 is a flowchart that depicts a method of selecting and viewing multimedia content according to an embodiment of this disclosure. In one embodiment, the method begins by utilizing a menu to select one or more of a plurality of subsets of multimedia content stored on a management server with the selected multimedia content comprising two or more photos (step 2302). The method further comprises receiving only the selected multimedia content (step 2304), and displaying a first photo of the selected multimedia content on a display of the media device while a second photo is being downloaded to the media device (step 2306).

Although system 100 is described as organizing the photos into five categories, one or ordinary skill in the art will realize that more or less or even different categories can be utilized depending upon the particular application. For example, a real estate agent may allow potential buyers to access the photos of the homes that the agent is showing by entering the agent's phone number instead of a password into system 100. In this case, for example, instead of storing the photos of the homes by Participants, the photos are stored by Rooms. This allows a potential buyer to compare rooms, such as kitchens and bathrooms, of different houses. Categories such as Occasions would be eliminated in this case.

Also, the flowcharts of FIGS. 7, 8, 21, 22, and 23 depict process serialization to facilitate an understanding of disclosed embodiments and are not necessarily indicative of the serialization of the operations being performed. In various embodiments, the processing steps described in FIGS. 7 and 8 may be performed in varying order, and one or more depicted steps may be performed in parallel with other steps. Additionally, execution of some processing steps of FIGS. 7 and 8 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations also are possible without departing from the spirit and scope of this disclosure, as defined by the following claims.

What is claimed is:

1. A method comprising:
receiving an automatically-initiated media content transfer from a consumer device;
identifying the owner of the transferred media content;
determining if the media content is associated with a member based on the information received from the owner of the content; and
storing the transferred media content to a memory based on the member determined to be associated with the media content.

2. A method in accordance with claim 1 further comprising:
allowing at least one of the owner or approved users to search the memory for the media content associated with the member by selecting the member.

3. A method in accordance with claim 1 further comprising:
downloading to a media device of at least one of the owner or one or more approved users only the multimedia content associated with the member.

4. A method in accordance with claim 1 further comprising:
restricting access to the transferred media content in the memory to approved users.

5. A method in accordance with claim 1 further comprising:
automatically downloading the transferred media content in the memory to approved users.

6. A system comprising:
a first menu that prompts a user to enter information associated with two or more members;
a management server configured to receive the information from the user, the management server also configured to receive a media content from the user and automatically determine if the media content is associated with a member based on the information received from the user;
a memory component configured to store the media content to a memory based on the member determined to be associated with the media content; and
a second menu that allows the user to search the memory for the media content associated with the member by selecting the member.

7. A system in accordance with claim 6 wherein the management server downloads to a media device of the user only the multimedia content associated with the member.

8. A system in accordance with claim 7 wherein the management server allows the user to select whether to view the downloaded multimedia content on the media device as a video, still photos, or in a pan-and-zoom mode.

9. A system in accordance with claim 7 wherein the management server displays the downloaded multimedia content on the media device of the user one frame at a time.

10. A method comprising:
receiving a plurality of multimedia content;
automatically organizing the plurality of multimedia content according to two or more categories; and
utilizing a menu that allows a user to select at least one of the two or more categories; and
downloading to the media device of the user only the multimedia content that corresponds to the selected categories.

11. A method in accordance with claim 10 further comprising allowing the user to select whether to view the downloaded multimedia content on the media device as a video, still photos, or in a pan-and-zoom mode.

12. A method in accordance with claim 10 further comprising displaying the downloaded multimedia content on the media device of the user one frame at a time.

13. A system comprising:
a management server configured to receive a plurality of multimedia content from a user and automatically organize the plurality of multimedia content based on two or more categories; and
a menu that allows the user to select at least one of the two or more categories,
wherein only the multimedia content that corresponds to a selected category is downloaded to a media device of the user.

14. A system in accordance with claim 13 wherein the management server allows the user to select whether to view the downloaded multimedia content on the media device as a video, still photos, or in a pan-and-zoom mode.

15. A system in accordance with claim 13 wherein the management server displays the downloaded multimedia content on the media device of the user one frame at a time.

16. A media device capable of:
utilizing a menu to select one or more of a plurality of subsets of multimedia content stored on a management server, the selected multimedia content comprising two or more photos;
receiving only the selected multimedia content; and
displaying a first photo of the selected multimedia content on a display of the media device while a second photo is being downloaded to the media device.

17. A media device in accordance with claim 16 wherein the plurality of subsets of multimedia content comprises two or more members based on the information received from the owner of the multimedia content.

18. A media device in accordance with claim 16 wherein the plurality of subsets of multimedia content comprises two or more categories.

19. A media device in accordance with claim 16 wherein the multimedia content is downloaded in a 640:480 format and displayed in a 320:240 format.

20. A media device in accordance with claim 16 wherein the media device utilizes a circular buffer to store a portion of the selected multimedia.
